(19) United States
(12) Patent Application Publication
(10) Pub. No.: US 2005/0106979 A1
(43) Pub. Date: May 19, 2005

(54) Personal care and surface cleaning article

(76) Inventors: Gerard Scheubel, (US); Albert R. Kelly, Douglaston, NY (US)

Correspondence Address: EVELYN M. SOMMER, 250 PARK AVE, RM 825, NEW YORK, NY, 10221, US

(21) Appl. No.: 10/833,580

(22) Filed: Apr. 29, 2004

Related U.S. Application Data
(63) Continuation-in-part of application No. 10/222,401, filed on Aug. 16, 2002, now abandoned.
Application No. 10/222,401 is a continuation-in-part of application No. 10/021,395, filed on Dec. 19, 2001.

(51) Int. Cl. B32B 5/02; B32B 27/12; D04H 1/46; D04H 3/10

(52) U.S. Cl. 442/387; 442/381; 442/389; 442/402; 442/403; 442/405; 428/219; 442/121; 442/123

(57) ABSTRACT

Flexible, substantially dry, disposable article suitable as a personal care article for cleansing and conditioning skin, sanitizing and disinfecting hard surfaces, methods of manufacturing and using the same wherein the article comprises: first, a water insoluble flexible nonwoven thermoplastic outer layer having an outer and inner surface; a core layer possessing low density, high absorbency, and high stretch capacity, containing a treatment composition adapted for cleaning, sanitizing or disinfecting hard surfaces or for personal cleansing and conditioning and a second water insoluble flexible nonwoven thermoplastic layer having an outer and inner surface positioned so its inner surface is opposite the inner surface of the first layer; the core layer having been mechanically through-bonded by needling to and between the first and second layers so as to form a unified article having pin dot perforations of an average pore opening size of less than about 300 microns and preferably less than 100 microns in diameter formed by the needling extending through all three of said layers. The invention also contemplates the articles which have not been treated with a treatment composition.

This application is a continuation-in-part of application Ser. No. 10/222,401 filed Aug. 16, 2002, which is a continuation-in-part of application Ser. No. 10/021,395, filed Dec. 19, 2001.

### FIELD OF THE INVENTION

The present invention relates to substantially dry, flexible disposable articles suitable as personal care articles for cleaning and conditioning skin or for cleaning, sanitizing and disinfecting hard surfaces, methods for manufacturing and for using the same.

Treated flexible articles for personal care and for cleaning, sanitizing and disinfecting hard surfaces are known. These articles are generally single ply structures that have been coated, sprayed, or impregnated with a treatment composition that is activated on being wetted with water. The articles with the treatment composition incorporated therein are substantially dry to the touch. A disadvantage of these articles is that when large surfaces are involved or when it is desired that the article be used for more than one use, necessitating the rewetting of the article to reactivate the treatment composition incorporated therein, that on the first wetting of the article, the active ingredients are substantially completely released such that the intended larger or multi-stage cleaning task cannot be articles is that the use of higher levels of treatment composition adversely affects hand-feel, the heavily treated articles feeling wet, lubricious or boardy.

A key requisite for producing longer-lasting cleaning articles is inclusion of enough treatment composition for the tasks intended, and provisions both for accelerating activation of the treatment composition by water and for controlling the release of the activated treatment composition over time. Traditionally, this had been accomplished with the use of concentrated treatment compositions that contain little or no water, that are solid or semi-solid at room temperatures, that are coated onto the surface of a flexible substrate at elevated temperatures, and then allowed to dry as a thin coating at ambient temperatures. The disadvantages of such coatings include lubricity of the resultant wax-like coatings, boardy hand-feel and an inability to control activation or release of the treatment composition; all of which depend upon the nature of the substrate and of the chemistry of the treatment compositions.

In an earlier filed application, Ser. No. 10/021,395, a disposable article useful for personal care and cleaning hard surfaces is disclosed comprising a first water insoluble flexible nonwoven thermoplastic layer, a second water insoluble flexible nonwoven thermoplastic layer, an intermediate core layer of a nonwoven material, the core layer being ultrasonically bonded to and between the first and second layers so as to form a unified article having pin dot perforations extending through all three layers.

The applicants have now found that wipes produced as a uniform article by mechanical web bonding or needling first and second outer layers so as to enclose a highly absorbent core layer, characterized by low density and high stretch capacity, so as to provide a through bonded article having perforations within a specific range of diameters extending through all three of the layers, possess the above-mentioned characteristics for providing a substantially dry, flexible, and long-lasting disposable article suitable for repeated use.

An object of this invention is to provide a substantially dry, flexible cleaning article useful for cleaning, sanitizing and disinfecting hard surfaces that can be activated with water and reactivated for continued use or repeated use, until the cleaning task or tasks are completed.

Another object of this invention is a flexible, substantially dry, cleaning article having incorporated into its structure, treatment composition in an amount of from 25 to 300 percent of the structure's total basis weight without the hand feel being adversely affected and without any loss of treatment composition from the article prior to actual use thereof.

It is another object of the invention to provide such cleaning articles which are disposable without giving rise to ecological or other problems.

Still another object is a cleaning article adapted for controlled and repeated release of the active ingredients in the treatment composition incorporated in its structure.

Yet another object is to provide a cleaning article adapted for controlled and repeated release of the active ingredients present in the treatment composition incorporated in the articles' structure.

Yet another object is to provide a cleaning article adapted for controlled and repeated release of the active ingredients present in the treatment composition incorporated in its structure and adapted for use for personal care.

Yet another object is to provide a cleaning article adapted for controlled and repeated release of the active ingredients present in the treatment composition incorporated in its structure and adapted for use for cleaning, sanitizing, and disinfecting hard surfaces.

Still a further object of the invention is to provide a cleaning article adapted for controlled and repeated release of the active ingredients present in the treatment composition incorporated in its structure having different surface textures on opposite sides thereof.

Yet another object of the invention is to provide a cleaning article adapted for controlled and repeated release of the active ingredients present in the treatment composition incorporated in its structure having an outer surface that can be imprinted for labeling, decorative or instructional purposes.

Disposable articles as herein disclosed are intended for single use, as well as multiple uses, i.e., up to 12 and more uses and as such are more disposable than reusable sponges, cloths or pads which can develop bacterial growth, unpleasant odors and other undesirable characteristics.

These and other objects will become readily apparent from a reading of the detailed description of the invention that follows.

### BRIEF DESCRIPTION OF THE DRAWINGS

FIG. 1 is photographs of three-ply needle punched composite articles using conventional core material and the core material disclosed in this invention.

FIG. 2 is photographs (enlarged 200%) of three-ply needle punched composite articles using conventional core material and the core material disclosed in this invention.

FIG. 3 is a photograph of two three-ply needle punched composite articles juxtaposed each using different core materials. Left side: using the core material disclosed in this invention. Right side: using conventional core material.

FIG. 4 is a photograph of the fully expressed wipes. A: using conventional core material. B: using the core material disclosed in this invention.

### DETAILED DESCRIPTION OF THE INVENTION

A disposable flexible article useful for cleaning, sanitizing and disinfecting hard surfaces, adapted for inclusion of a cleaning solution in the core layer thereof and for controlled and repeated release thereof, comprising:
a) a first water insoluble nonwoven layer comprised substantially of synthetic fibers having outer and inner surfaces,
b) a water insoluble core layer made of cellulosic wadding having a density less than 0.3 and preferably less than 0.2 grams per cubic centimeter, having a stretch capacity of at least 30%, having a water absorbent capacity of at least 12, preferably up to 17 and most preferably 12-15 grams per gram of its basis weight, and
c) a second water insoluble nonwoven layer comprised substantially of synthetic fibers having outer and inner surfaces wherein the core layer is positioned between the inner surfaces of said first and second layers and the first, second and intermediate core layer are mechanically through-bonded by needling to form a unified article having perforations of less than 300 microns in diameter extending through all of said layers, said perforations having been formed during said mechanical bonding, wherein said perforations assist in controlling water absorption into the core required for activating the cleaning solution and for the controlled and repeated release of the cleaning solution upon its activation by said absorbed water.

The invention also contemplates flexible substantially dry disposable articles comprising a first water insoluble flexible nonwoven thermoplastic outer layer having an outer and an inner surface, a core layer formed at least in part of a cellulosic wadding material possessing low density of less than 0.3 grams per cubic centimeter and preferably less than 0.2 grams per cubic centimeter, high absorbent capacity and high stretch capacity, containing a treatment composition adapted for cleaning, sanitizing or disinfecting hard surfaces or for personal cleansing and conditioning and a second water insoluble flexible nonwoven thermoplastic layer having an outer and inner surface positioned so its inner surface is opposite the inner surface of the first layer, the core layer being mechanically through-bonded by needling to and between the first and second layers so as to form a unified article having perforations at less than 300 microns in diameter formed by said mechanical bonding, i.e., needling extending through all three of said layers.

When the term “thermoplastic layers” is used, it is intended to include layers, which are entirely or substantially composed of thermoplastic fibers. It is however possible for the thermoplastic layer to include lesser amounts of natural fibers such as rayon, cotton, viscose, lyocell or Tencel®.

Cellulosic materials suitable for use in forming the core layer are fibers composed or derived from cellulose. Examples are paper (cellulose), hemp and cotton. Particularly preferred fibers are derived from wood pulp. The cellulosic core can be a wadding or other like cellulosic material. It is critical for the repeated use of the wipe to employ a lightweight and highly absorbent core structure. The desired a density of less than 0.3 grams per cubic centimeter and preferably no more than 0.2 grams per cubic centimeter and can absorb up to 17 grams per gram of its basis weight, preferably 12 to 15 grams per gram of its basis weight. As a comparison, conventional papers have densities well in excess of 0.3 grams per cubic centimeter, for example, 0.5 to 0.7 grams per cubic centimeter, and an absorbency of about 4 to 7 grams per gram of their basis weight. Because it is essential for the core to retain a relatively large amount of treatment composition, generally more than 6 grams per wipe, to allow for repeated use, the use of a low absorbency cores yield wipes which become nearly completely or over saturated, when the required amount of treatment approaches or exceeds the absorption capacity of the core. Thus, conventional paper cores, with an absorbent capacity of only up to 7 grams per gram of its basis weight, will not yield a wiper product that can retain and gradually release more than 6 grams of composition needed to be effective. Attempting to treat a 7″×8″ wiper product having a core with a basis weight of 28 lbs/ream with a 6-gram add-on would result in nearly completely or over-saturation of the core. In that event, even small amounts of pressure will cause migration of the treatment composition into the outer layers of the wipes in the package. This can give rise to more rapid activation and release of the treatment composition and a reduced span of use.

Additionally, for the cellulosic core to survive the multidirectional tensions incurred under high speed converting conditions and similar tensions incurred in-use, the core must possess high stretch capacity, well in excess of the 1% to 2% commonly found with conventional paper cores. Consequently, conventional paper function of such a wipe made with conventional paper cores, including their potential for repeated use will be severely compromised.

The preferred core is a cellulosic wadding core with a basis weight of 22 lbs/ream to 35 lbs/ream, preferably 28 lbs/ream, that has an unusually high stretch capabilities of about 75%, and a low density of less than 0.2 g/cm³, preferably less than 0.1 g/cm³. Shawano Specialty Papers produces cellulosic wadding of this type as Grade 1804. These characteristics allow the core to survive needling and preserve structural integrity of the composite structure under the multidirectional tensions during converting and in-use. The high absorption capacity of up to 17 grams of water per gram of basis weight, or 27.2 grams of water per 7″×8″ wipe, is also critical in allowing the core to absorb and retain 6 grams of cleaning composition (representing about 22% of its capacity) without risking treatment composition migration, or its premature release.

The term mechanical bonding is taken to mean the bonding together of fiber webs by using needles. The idea of bonding fibrous material usually composed of coarse natural fibers or recycled cuttings or waste, by vertical perforation by many barbed needles to make a web, is a very old one. The technique has been used in industry since the 1870s. It enables textiles to be made for special purposes, such as upholstering, insulating, and dampening, either out of fibers which were difficult to spin or could not be spun at all, from fibers that could not be felted, such as wool, and animal hair. similar to wool. They were trying to replace the felting process that takes place in wool with the needling of carded web made from synthetic fibers and to replace the felting process by shrinking the needled material.

High quality synthetic fibers with new properties began to appear and new uses were found for them, which gave them the incentive for further development of needling techniques, e.g., for needle punched floor coverings.

The mechanical bonding of fiber webs with needles is a technique now employed in the production of numerous products which not only compete with conventionally made textiles, but exhibit properties hitherto unknown and not attainable by any other method.

The properties of needled fabrics depend mainly on the kind of fiber involved; the method by which the web is made; the needling technique employed; together with the needle tooling. In needling, the bonding of the fiber web is the result of intertwining of the fibers and of the increased inter-fiber friction caused by the compression of the web.

Different types of needles are available and can be used to produce different types of effects, more particularly the size of the needles, the number and shape of the barbs in the working zone, determine the amount of fibers being reoriented due to the action of said needles, and so create the densified structure required. Needling's aim is to create a cohesive structure, density this web structure and bond fibrous structure through the action of the bards located on each needle through the cohesive structure. By reaching another fiber-based web, it creates an intimate bond within all layers. Thus, the needle used can determine the width and depth of the openings and the amount of the fibers that has to be reoriented. Needling's aim has been to compress and bond the fibers together.

While needle punching has been available for some time, the technique has been applied to synthetic or natural fibers having sufficient length to be carried by the needles. Single webs are most frequently used and while it is known to use needle punching for mechanically bonding more than one web to form a composite, the fibers from which the webs are formed while differing in properties, i.e., flexural strength, tensile load and extensibility as well as in thickness, length and distribution of strength, have all been synthetic. Needling with cellulosic material, and particularly wood pulp derived materials, because of the short length of the natural fibers and their fineness, etc., was not believed possible without encountering considerable difficulties. The inventors herein have now found that the composite of the invention, with inner and outer nonwoven thermoplastics enclosing therein a low density wadding core with high stretch and high absorbency capacity, can be mechanically bonded together by needle punching without compromising the structural integrity of the cellulosic core during needling or when subjected to tensions under high speed converting or in-use, and at the same time, discrete selection of needles can result in the creation of perforations with the desired diameters for controlled absorption of water for activation of the treatment time, discrete selection of needles can result in the creation of perforations with the desired diameters for controlled absorption of water for activation of the treatment composition, and the controlled release of the activated treatment composition over time. One object of the needling is to join together the different fiber webs or layers by piercing them evenly with the needle to push small bunches of fiber there through, the nature of the cellulosic web having been predetermined to insure that it will maintain its integrity during the needling process. The other object of the needling is to provide perforations of desired sizes and density to allow the metered absorption of water and the controlled release of the activated treatment composition over time, provided that needles with a specific range of outside diameters are employed. It is possible to separate the two objects into two unique operations as an alternative embodiment, e.g., needling using non-barbed needles to provide perforations of desired sizes, and bonding the three layers together using other means, such as laminating and ultrasonic bonding.

Conventional needling machines can be used. Suitable machinery and processes are described in Non-Woven Bonded Fabrics, Editors, J. Lunenschloss and W. Albrecht, Ellis Horwood Series in Industrial Technology, Ellis Horwood Limited, Chichester. However, needles used for conventional needlepunching, which possess outside diameters of 450 to 600 microns, cannot be used for the intended purpose. For the purpose of metered absorption of water and the controlled release of the activated treatment composition, it is critical to use needles with much smaller outside diameters, which produce perforations with a diameter of less than 300 microns, preferably less than 100 microns.

In another aspect of the invention, additional layers of thermoplastic materials such as dry laid resin bonded fabrics, heat bonded fabrics, spun bonded or hydro-entangled fabrics composed of polypropylene and/or polyester, or needle punched polypropylene and/or polyester may be disposed adjacent to the outer layers or used to form the bottom surface or the top surface, of the cleansing article respectively so that articles of 4, 5, 6 or seven layers are possible, however in all instances the innermost three layers are those described herein.

Preferably, the first and second outer layers are composed essentially of thermoplastic firer based nonwovens selected from polyesters, polyolefins, polyamides and polypropylene and most preferably spun laced, hydro-entangled polyester, or needle punched polyester or polypropylene. The fibers can be made of single polymer component or can be bio-component fibers having a side-by-side or sheath core structure. The first and second outer layers or additional layers provided on the first and second layers can also be comprised of a mixture of the thermoplastic fibers having abrasive particles incorporated therein or which can be flame treated or singed to form roughened or hardened surfaces. The abrasive particles are added in order to form a rough or abrasive surface on at least one face of the article. Abrasive particles can be created by melting locally thermoplastic polymers thus creating polymer hard points through partial fusion of fiber ends or fiber bundles. The heat treatment applied can be a locally intense heating provided by an open flame in a process called singeing or high intensity infrared heating or similar methods capable of melting only parts of the fibrous structure. Another desired layer taking care of hardening only locally that layer. In accordance with another embodiment of this invention a supple fabric is provided containing metallic fibers of appropriate size blended to the thermoplastic fibers in order to impart roughness to the desired layer. The metallic fibers can be selected from among stainless steel fibers or any other metallic fiber such as soft iron. An outer layer can also be embossed or debossed ultrasonically so that it exhibits a pattern of raised and depressed areas or surface aberrations as an alternative to including abrasive particles or flame treating and the like. This abrasive or embossed surface also serves to enhance the cleaning or exfoliating effect in the case of the personal care article and the cleaning and scouring effect in the case of the article for cleaning hard surfaces.

The thermoplastics nonwovens can incorporate coloring substances therein so that they present a varied appearance, i.e., the outer layers being of the same or different colors.

To form the disposable cleaning article of this invention, a core layer is mechanically through-bonded by needling while it is positioned between the outer layers using needling machinery and employing conditions sufficient to achieve the bonding of the elements and to perforate all of the layers effectively. The perforations of the layers should have a diameter of less than 300 microns and preferably less than 100 microns and be rendered fluid permeable. The small perforations help control and meter water adsorption, activation, and release of the cleansing or treatment component, and thereby extend the usable life of the wipe. If the wipe would be shortened due to the faster absorption of water and the more rapid release of the activated treatment composition upon initial use. If more layers are present, the bonding and formation of apertures or perforations is achieved in the same manner and to the same effect.

The term “disposable” as used herein means that the needle through-bonded articles are designed to be re-activated a limited number of times and then discarded, preferably less than about 45 times and most preferably more than a single usage event. For the purpose of the instant invention articles, all of which are specifically designed for disposability, through-bonding enhances performance and mandates disposability by facilitating controlled de-lamination to be engineered into the product's design specifications.

The term “substantially dry”, as used herein, means that the articles exhibit a hand feel that may feel slightly lubricious, but not water-wet.

The disposable cleaning articles of the invention must comprise a water insoluble inner core element and at least two outer water insoluble surface contacting elements with at least one outer surface element on each side of the core element, wherein the article contains apertures of less than 300 microns and preferably less than 100 microns in diameter extending through all three of the elements or layers. The core element may include a cellulosic substrate or another nonwoven web, i.e., a web composed in the main of cellulosic fibers having wet strength for use. In its preferred embodiment, the core element should have an absorbent capacity of up to 17 grams per gram of core material. The wet wicking rate of the core should be less than about 25 seconds. The basis weight of the core should be from about 20 to about 44 grams per square meter. Materials for the core are selected from the group of cellulosic, natural materials such as cotton, jute, hemp, wood pulp, and mixtures thereof, which should be of low density, less than 0.3 grams per cubic centimeter. It is critical for the repeated use of the wipe to employ lightweight and highly absorbent core structures. It is also critical for the core to have a high stretch capability, at least 30% and preferably up to 75%, which is necessary to preserve the structural integrity and prevent the formation of fissures in the core during needling, high speed converting or in use. The desired cellulosic material possess a density of less than 0.3 grams per cubic centimeter and preferably no more than 0.2 grams per cubic centimeter and can absorb up to 17 grams per gram of their basis weight, and an stretch capability of about 75%. By comparison, standard papers have densities well in excess of 0.3 grams per cubic centimeter, absorb only up to about 7 grams per gram of their basis weight and can stretch only by about 1.5%. The use of conventional paper results in a wipe product that cannot retain and gradually release the high load of treatment composition required for products of this type to be effective.

The cellulosic wadding core is critically important for assuring effective performance of the treated composite for the following reasons.

1. To inhibit migration of the treatment composition incorporated therein,

4. To expand and soften the activated wipes.

After formation of the composite article, the article can be treated in the conventional manner by impregnation, dipping, spraying or coating the article with a treatment composition, the treated article remaining substantially dry to the touch. The article may also be treated so that it includes the treatment composition comprising the active ingredients in the form of a substantially dry composition that does not permeate or impregnate either of the outer layers, and effectively resides between the inner surfaces of the first and second or outer layers.

The first and second and any additional outer layers and the core are bonded together to maintain the integrity of the article and to provide the article in the thermoplastic outer layers with apertures such that the composite layers become fluid permeable. The apertures encourage the introduction of water or other fluids into the core to activate the treatment composition that has been impregnated, coated, sprayed or otherwise incorporated therein. The application of water, pressure and friction facilitates and controls the metered release of the activated composition.

The bonding of the core with the outer layers is executed mechanically by needling and has to be conducted so all of the layers are completely through-bonded and through-perforated. Needling is conducted in the conventional manner, utilizing the conventional needling equipment and needles of appropriate outside diameters adapted for producing the through perforations of desirable sizes as described herein.

The cleaning articles of the invention contain in the core layer a treatment

The treatment composition for the article to be used for personal cleansing can include, in addition to surfactants and preferably lathering surfactants, emollients, lubricants, protectants, deodorants or medicaments.

The apertures should preferably be uniform in size and shape and necessarily of small size, preferably having an average diameter of less than 300 microns and most preferably less than 100 microns. In addition to the two layers and core, other insoluble layers may be present disposed adjacent to the outer surface(s) of the two layers. These additional layers can include abrasives and other non-fibrous materials. The bonding of the multi layers takes place mechanically by needling and is regulated so as to bond the layers and to produce apertures or openings extended into and through all of the layers.

The articles intended for cleaning hard surfaces can have incorporated herein compositions as described in U.S. Pat. No. 6,141,644 the entirety of which is incorporated herein by reference.

The treatment composition for the article when it is to be used for cleaning, sanitizing and disinfecting hard surfaces, can include, in addition to surfactants, an antiseptic, antibacterial, wax, waterproofing, polishing or other agents as are conventionally used in cleaning compositions intended for cleaning and protecting hard surfaces in homes, restaurants, hospitals, nursing homes for private and industrial use and the like. They can be used as mopping and dusting cloths, and as polishing and cleaning cloths.

In a preferred embodiment for personal skin care, the treatment composition includes a surfactant and at least one member of the group of emollients, lubricants, exposed to water at the point of use and pressure applied, as by squeezing, an unstable emulsion and in the case of the use of a foaming surfactant, a lather is formed which releases the components of the cleansing treatment composition onto the skin or hair of the individual. The treatment compositions used in connection with personal skin care articles is most advantageously used to provide 25 to about 300 percent of add-on treatment composition based upon total basis weight of the final product.

The outer layers of the article of the invention may have different textures and abrasiveness. Differently textured surfaces can be adapted so as to provide an abrasive side for more intensive cleaning and a softer absorbent side for lighter and more gentle cleaning.

The surfactants employed in the treatment compositions are preferably lathering surfactants, but this is not required and may include anionic, cationic, amphoteric and non-ionic surfactants either separately or in combination and preferably include as anionic surfactants, the phosphates, taurates, sulfates, sarcosinates, isothionates, etc, for example ammonium lauroyl sulfate, sodium lauroyl sarcosinate, sodium lauroyl lactylate, etc.

Nonionic surfactants which can be used include amine oxides, alkoxylated fatty acid esters, polyhydroxy fatty acid amides, alkyl glycosides and the like exemplified by lauramine oxide, sucrose laurate, sucrose cocoate and the like.

Instances of suitable amphoteric surfactants are the amino alkanoates, alkyl amino acetates, hydroxy, sultaines, betaines, etc., as exemplified by sodium-3-

[symbol]

The substantially dry core is interposed between the two water insoluble outer layers, and the resultant lamination is mechanically bonded to form a perforated uniform article and is then treated with the treatment composition.

Preferably the article of the invention comprises three discrete elements that have been mechanically through-bonded by needling to form a uniform perforated article. For the purpose of the mechanical bonding, the outer layers are preferably composed of similar synthetic fiber materials and the inner layer or core layer of a cellulose material and preferably a wood pulp derived material such as paper.

The disposable articles of the invention can accommodate from 25 to about 300 percent of treatment composition of the resulting structures' total basis weight without any loss of their excellent hand properties including feel, drape conformability and flexibility.

The disposable articles of the invention are substantially dry and are intended to be activated by water prior to use by saturation with water, by placing the article under a stream of water or by placing it in contact with a wet hard surface or wet skin. Upon activation with water the treatment composition is released by applying pressure and/or friction.

The articles all have in common a high absorption capacity facilitated by use of the absorbent cellulose fiber core. The apertures formed in the needling encourage rapid passage of water into and for gradual release of the treatment composition out of the device, the apertures being capable of modification to influence how the water gets in the article and amounts of the composition out of the article.

In order to describe the invention more fully and not by way of limitation, the following examples are presented.

1. THREE-PLY HARD SURFACE CLEANING CLOTHS—A single inner absorbent core element comprising a 28# cellulosic wadding, having a density of about 0.1 gram per cubic centimeter, that is interposed between a web of 1.2 ounce per square yard polyester material made of 3 denier fibers and 2.3 ounce polypropylene fiber material made of a blend of coarse fibers of 17 and 60 denier. These three elements are mechanically bonded together by needling to form a flexible article of controlled density. A calendar compression treatment is applied between two metallic rolls in order to achieve a thickness of 1/20^{th} of an inch and a pore opening of less than 100 microns. The resulting cloth when wet with water, and wrung dry provided an excellent cleaning device. The cloth exhibited a high water absorption capacity. It could be wet and wrung out many times without depleting its absorbency.

2. THREE-PLY HARD SURFACE CLEANING CLOTHS—A single inner absorbent core element comprising a 28# cellulosic wadding material, having a density of about 0.1 gram per cubic centimeter, that is interposed between a web of 1.2 ounce per square yard of polyester material made of 3 denier fibers and a 2.3 ounce polypropylene fiber material made of blend of coarse fibers of 17 and 60 denier. The three elements are mechanically bonded together by needling to form a flexible article of controlled density. A calendar compression treatment is applied between two metallic rolls in order to achieve a thickness of 1/20^{th} of an inch and a pore opening size of less than 100 microns. Because the treatment composition is treatment composition is absorbed into the cellulosic core. This treated core element weighs approximately 174 grams per square yard. The resulting cloth is then placed under running water and squeezed several times to provide a rich lathering foam providing excellent cleaning properties. The process was repeated approximately twelve times and still provided a rich lathering foam. This process was repeated approximately twelve more times and still provided a rich lathering foam. This process was repeated a further twelve times, at which point the lathering foam diminished.

3. FOUR-PLY HARD SURFACE CLEANING CLOTHS—A single, inner absorbent core element comprising a 28# cellulosic wadding, having a density of about 0.1 gram per cubic centimeter is imposed between a 1.2 ounce per square yard carded and cross-lapped polyester fabric made of 3 denier fibers and a 2.3 ounce polypropylene fiber material made of 17 deniers. The three elements are mechanically bonded together by needling to form a flexible article of controlled density. A calendar compression treatment is applied to the laminate between two metallic rolls in order to achieve a thickness of 1/20^{th} of an inch and an average pore opening size of less than 100 microns. The compressed fabric is subjected to an open flame treatment in order to impart the abrasion properties to the composite material. The article was impregnated with 90 grams per square yard of a highly concentrated hard surface surfactant containing treatment composition. This treated core element weighs approximately 126 grams per square yard and contains the activated treatment composition for ready release. The perforated polyethylene film layer is intended to present a partial fluid barrier that restricts the inward flow lathering foam. This process was repeated (well) over 24 (more) times before the foaming action began to dissipate.

4. FOUR-PLY HARD SURFACE CLEANING CLOTHS—A single, inner absorbent core element comprising a 28# cellulosic wadding material, having a density of about 0.1 gram per cubic centimeter is interposed between a 1.3 ounce polypropylene material which has been interfaced with a 0.5 milligram polyethylene film and a 1.0 ounce spun-bonded polyester material. The four layers are then bonded together mechanically by needling so as to form a flexible entity having perforated bonding points of less than 200 microns in diameter arranged in uniform pin-dot pattern through which fluids can pass into the treated core and the activated treatment following its delivery can be released outwardly. The perforated polyethylene film layer is intended to present a partial fluid barrier that restricts in use the inward flow of water and the subsequent release of activated treatment composition. The article is coated in three-quarter inch wide stripes with 60 grams per square yard of a highly concentrated hard surface surfactani containing composition, separated by one-half inch stripes having no coating. The treated article was then saturated with water and squeezed several times to produce a rich lathering foam. This process was repeated (well) over 24 (more) times before the foaming action began to dissipate.

5. THREE-PLY SKIN CLEANSING CLOTHS—A single, inner absorbent core element comprising a 35# cellulosic wadding material weighing approximately 48 grams per square yard is interposed between a 1.3 ounce resin-bonded, polyester material and a 1.0 ounce spun-bonded polyester material. The three elements are a diameter of less than 150 microns arranged in uniform pin-dot pattern that is visible on the spun-bonded polyester side only. The cloth is impregnated with 140 grams per square yard of a concentrated skin cleansing and conditioning composition. The treated article is then saturated under running water and squeezed several times to provide a rich, lathering foam. This process was repeated approximately 42 times, at which point the lathering foam diminished significantly.

In order to establish the critical nature of the properties of the core material and of the mechanical through bonded needling for the purposes intended, the following experiments were conducted and explained in the appended Declaration.
1. Cellulosic Core Material

The cellulosic core materials for fabricating the “standard” and “test” composites were selected to resemble or duplicate the core materials used commonly for wiping applications and by the invention, respectively. In order to eliminate unnecessary variables, the basis weights of both core materials were comparable. The methods for determining density, absorbency and stretch capacity are given as footnotes.
a) the “standard composite” incorporates a tissue core (hereafter referred to as “standard tissue”) with a basis weight of 28 lbs/ream, (Grade # 7571-280-0 from Shawano Specialty Papers) engineered for general wiping and filtration applications. As such, it has low stretch (1.5%), low bulk (5.3 mils), low absorbency (4 grams per gram) and relatively low density (0.3 grams per cubic centimeter). as “test tissue”) from Shawano Specialty Papers, specially engineered for use as an absorbent core in the article which is the subject of this patent application. As such, it has high stretch (75%), high bulk (17.4 mils), high absorbency (16.5 grams per gram of its basis weight), and an extremely low density (0.06 grams per cubic centimeter).
2. Cleaning Composition

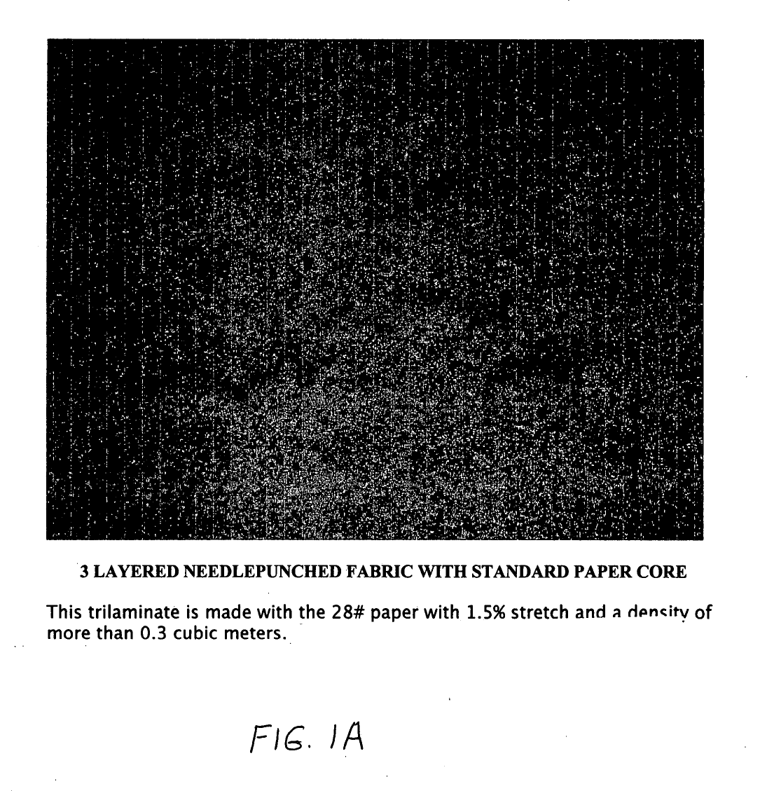

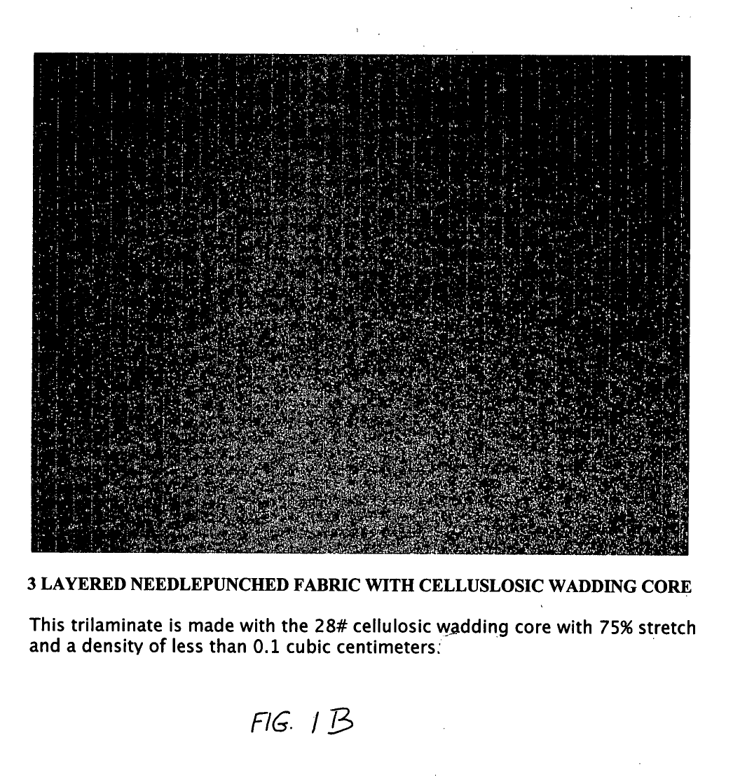

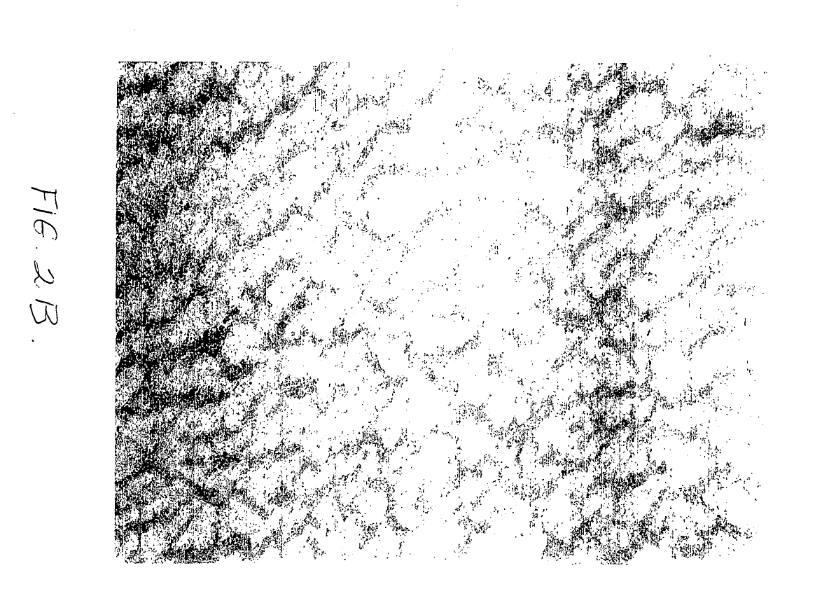

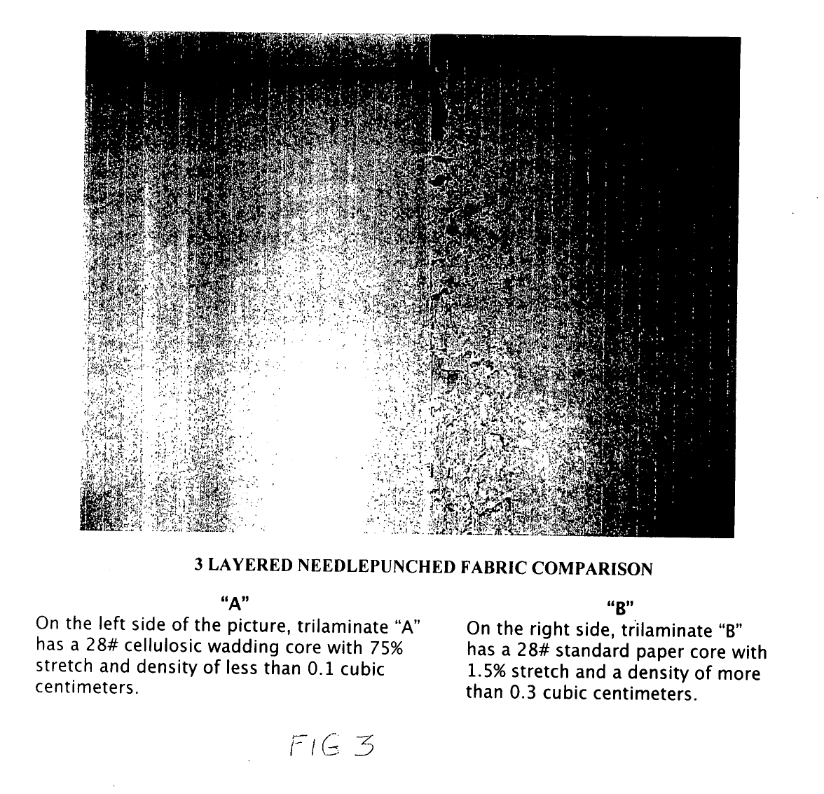

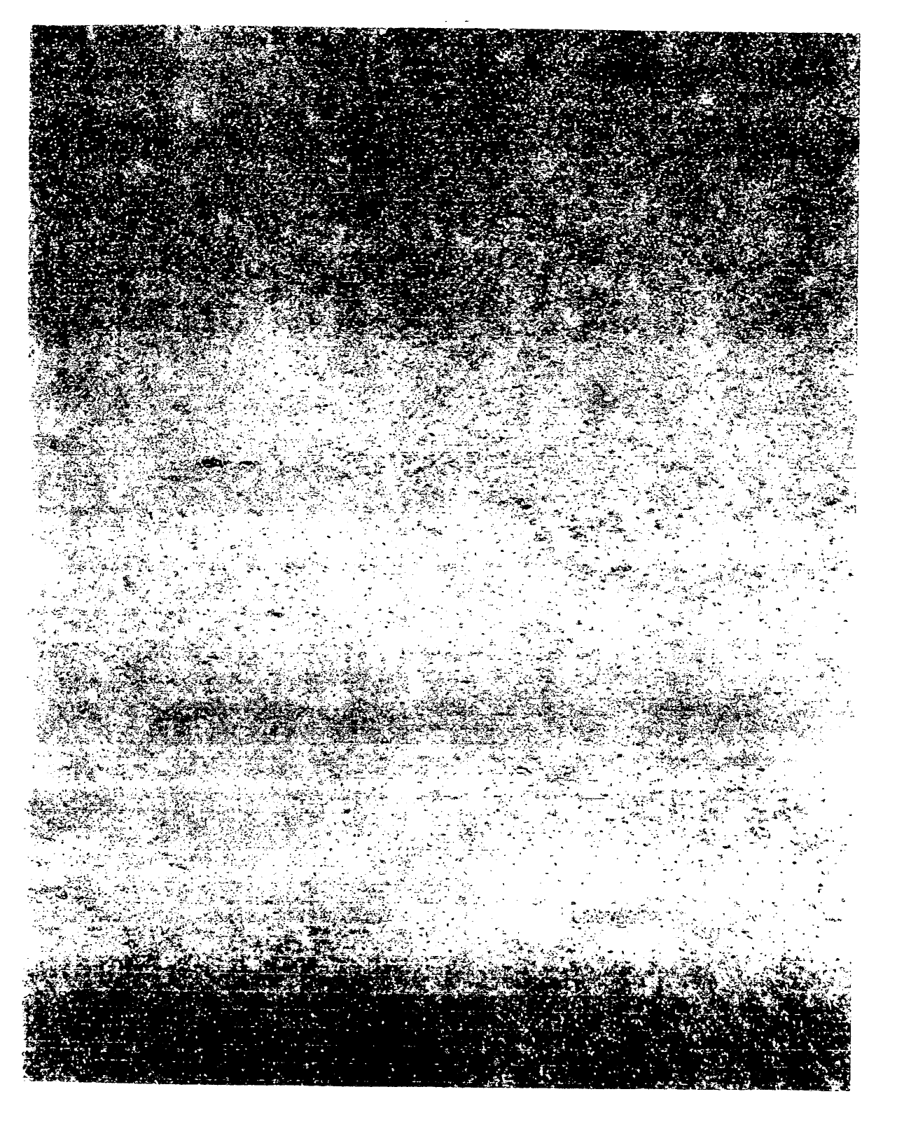

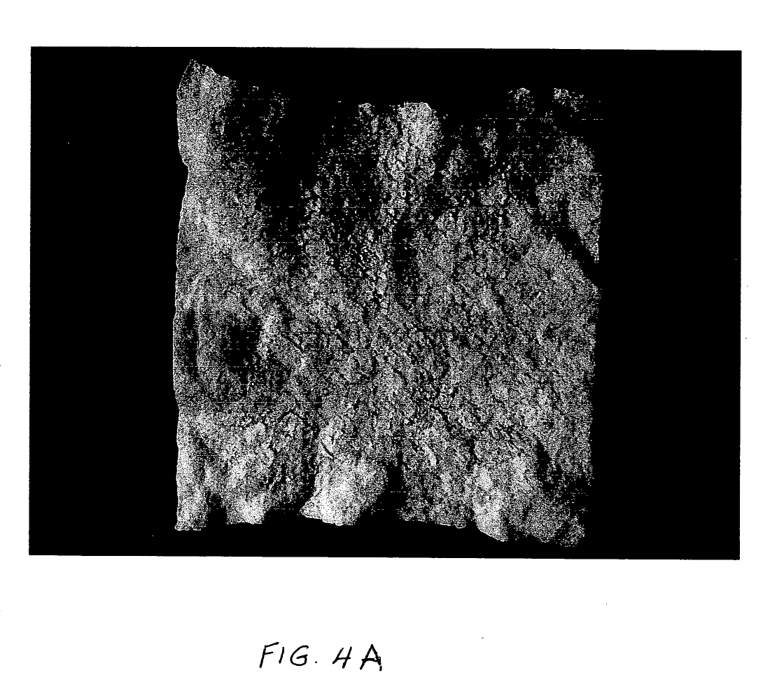

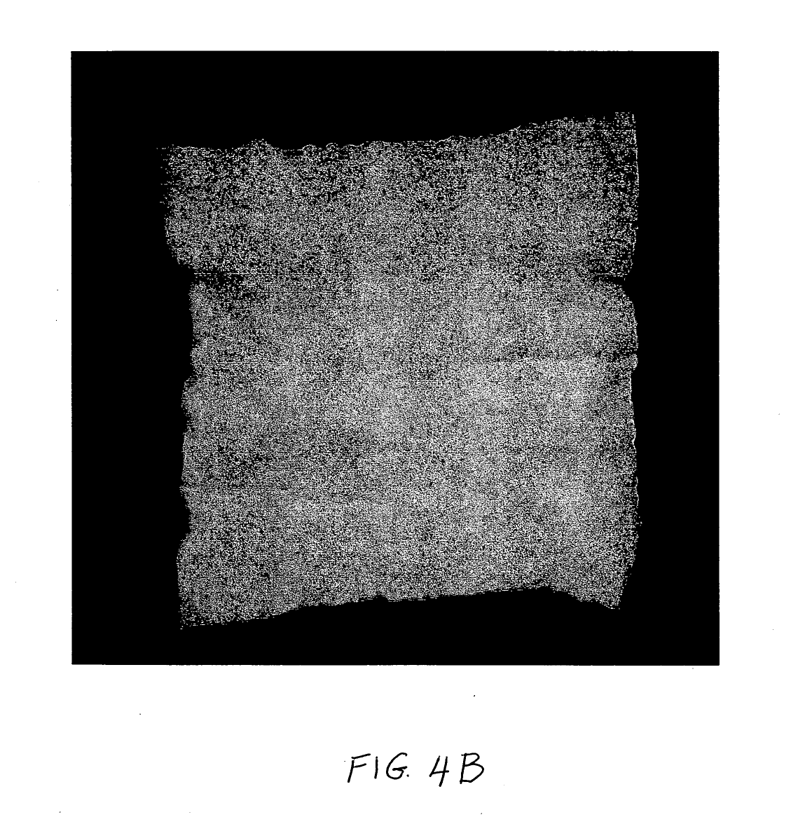

The cleaning composition used for the tests was a proprietary formulation for use on hard surfaces or skin. It is a high foaming surfactant formulation with a viscosity of less than 1,000 CPS. In previous experiments, it was determined that about 6 grams of this cleaning composition is needed in a dish wipe to wash an average sink load of dishes, or in a body washcloth to last for a full shower.
3. Different cellulosic core materials were tested for their absorbent capacity and their capability to retain and gradually release the targeted 6 gram active load per 7″×8″ sheet. Treated samples of these cores were laboratory tested to evaluate their relative absorbency of the treatment composition.
   a) A 7″×8″ sheet of “standard tissue” core, with an absorbent capacity of 4 grams per gram is completely saturated by the 6 grams of treatment composition.
   b) A 7″×8″ sheet of “test tissue” core, with an absorbent capacity of 17 grams per gram of its basis weight is far less than saturated by the 6 gram treatment composition, which represents only 22% of its absorbent capacity.
4. Both core materials were fabricated into three-ply needle punch composite structures using 40 gauge, two-barbed needles, at 90 perforation per square inch, with diameters of less than 300 microns. Photographs are included as FIG. 1, and enlarged photographs (enlarged 200%) are FIG. 2.
5. The relative structural integrity of the needle punched composites can be seen in the photograph shown as FIG. 3, which is the two composites juxtaposed in the process of being fabricated. The left side of the photograph is the “test composite” made with the high absorbency core using the “test tissue”, and the right side of the photograph is the “standard composite” made with the low absorbency core using the “standard tissue.”
6. Photograph of samples of the fully expressed wipes of each type (A and B) is shown as FIG. 4. It can be seen that the “standard composite” (A) wipe shows fissures (with lengths up to 6-8″ and widths up to 0.25-1″) and weakened structural integrity. The “test composite” (B) wipe has a soft and fluffy hand feel, and has fully retained its structural integrity.
7. Three wipes each of both composite structures made with “standard tissue” and “test tissue” were impregnated with 6 grams of cleaning composition, squeezed, and reactivated under tepid running water repeatedly.
   b) The “test composite” wipes exhibited high levels of foaming action and could be reactivated and squeezed an average of 43 times before the foaming action ceased.

Thus the “test tissue” wipes released the cleaning composition more gradually, and effectively lasted 35% longer.
8. The key observations and conclusions from these experiments include the following:
   a) Because the “standard tissue” core is saturated by the targeted 6 grams of treatment composition, the excess treatment composition migrates to the outer layers, causing a wetter hand feel of the treated composite, and a shorter duration of use.
   b) Because the high absorbency “test tissue” core is not saturated by the targeted 6 grams of treatment composition (which represents less than 22% of its absorbent capacity), there is no excess treatment composition to migrate to the outer layers, Thus the treated composite has a drier hand feel and a significantly longer duration of use.
   c) Because the “standard tissue” core of the “standard composite” has limited elongation of only 1.5% and a higher density of 0.3 grams per cubic centimeter, the needling process causes visible fissures and a severely weakens the composite's physical integrity. This was commonly observed in a dry, pretreated condition, and in a post-use condition. centimeter, the core survives the needling process intact and the composite retains its physical integrity.

Footnotes: methods employed for determining density, absorbency and stretch capacity.
A) Density—grams per cubic centimeter is determined by dividing basis weight in grams per square centimeter by dry bulk in centimeters: basis weight is determined by using Tappi Method 410: dry bulk is determined by using Tappi Method 411.
B) Absorbency—is determined by placing 5 grams of dry test material into a wire cage; dipping the container into water and soak for one minute; removing from water and allowing the test material to drip for 30 seconds; weight water pickup and calculate in grams per gram.
C) Stretch—is determined by a “tensile test”, based upon the amount of elongation that occurs with the test material up to the breaking point.

1. A disposable flexible article useful for cleaning, sanitizing and disinfecting hard surfaces, adapted for inclusion of a cleaning solution in the core layer thereof and for controlled and repeated release thereof, comprising:
d) a first water insoluble non woven layer comprised substantially of synthetic fibers having outer and inner surfaces,
e) a water insoluble core layer made of a cellulosic wadding material having a density less than 0.3 grams per cubic centimeter, having an stretch capacity of at least 30%, and having an absorbent capacity of at least 12 grams per gram of its basis weight, and
f) a second water insoluble non woven layer comprised substantially of synthetic fibers having outer and inner surfaces, wherein the core layer is positioned between the inner surfaces of said first and second layers and the first, second and intermediate core layers are mechanically through-bonded by needling to form a unified article having perforations of less than 300 microns in diameter extending through all of said layers, said perforations having been formed during said mechanical bonding, wherein said perforations assist in controlling water absorption into the core required for activating the cleaning solution and for the controlled and repeated release of the cleaning solution on its activation by said absorbed layer.

2. A substantially dry disposable flexible article useful for cleaning, sanitizing and disinfecting hard surfaces, adapted for inclusion of a cleaning solution for cleaning, sanitizing and disinfecting such hard surfaces and for controlled and repeated release thereof, comprising:
a) a first water insoluble non woven layer comprised substantially of synthetic fibers having outer and inner surfaces,
b) a water insoluble core layer made of a cellulosic wadding material having a density of less than 0.3 grams per cubic centimeter, having an stretch capacity of at least 30%, having an absorbent capacity of at least 12 grams per gram of its basis weight, and incorporating about 25 to about 300% of the article's total basis weight of a cleaning solution including a surfactant adapted for cleaning hard surfaces,
c) a second water insoluble non-woven layer comprised substantially of synthetic fibers having inner and outer surfaces wherein the core layer is positioned between the inner surfaces of said first and second layers and the first, second and intermediate core layers are mechanically through-bonded by needling to form a unified article having perforations of less than 300 microns in diameter extending through all of said layers, said perforations having been formed during said mechanical bonding, wherein said perforations assist in controlling water absorption into the core required for activating the cleaning solution and for the controlled and repeated release of the cleaning solution on its activation by said absorbed water.

3. A disposable flexible article according to claim 2 wherein said treatment composition contains surfactant selected from the group consisting of anionic, nonionic, amphoteric surfactants and mixtures thereof.

4. A disposable flexible article according to claim 3 wherein said anionic surfactant is a member selected from the group consisting of sarcosinates, sulfates, isothionates, phosphates, taurates, lactylates, glutamates, and mixtures thereof.

5. A disposable flexible article according to claim 3 wherein said non-ionic surfactant is a member selected from the group consisting of amine oxides, alkyl glucosides, alkyl polyglucosides, polyhydroxy fatty acid amides, alkoxylated fatty acid esters, sucrose esters, and mixtures thereof.

6. A disposable flexible article according to claim 3 wherein said amphoteric surfactant is a member selected from the group consisting of betaines, sultaines, hydroxysultaines, alkyliminoacetates, iminodialkanoates, aminoalkanoates, and mixtures thereof.

7. A disposable flexible article according to claim 2 wherein at least one additional layer is present having been applied to the outer surface of at least one of said first and second layers prior to the mechanical bonding of the three layers.

8. A disposable flexible article according to claim 2 wherein at least one of said first and second layers contains abrasive material.

9. A disposable flexible article according to claim 7 wherein said additional layer has a different texture than said first or second layer.

10. A disposable flexible article according to claim 9 wherein said outermost layers have imparted thereto a different texture formed by singeing or flame treatment of at least one of said layers.

11. A disposable flexible article according to claim 7 wherein said additional layer serves a partial fluid barrier.

12. A disposable flexible article according to claim 9 wherein said different texture has been formed by flame treatment.

13. A disposable flexible article according to claim 2, wherein said perforations are less than 200 microns in diameter, said perforations ensuring the controlled passage of water into the core layer for the activation of the treatment composition and the controlled release of treatment composition activated by contact with said water out of the article.

14. A disposable flexible article according to claim 1 wherein said core layer has a density of less than about 0.2 grams per cubic centimeter.

15. A disposable flexible article according to claim 1 wherein said core layer has a density of less than about 0.1 grams per cubic centimeter.

16. A disposable flexible article according to claim 2 wherein said core layer has a density of less than about 0.2 grams per cubic centimeter.

17. A disposable flexible article according to claim 2 wherein said core layer has a density of less than about 0.1 grams per cubic centimeter.

18. A disposable flexible article according to claim 1 wherein said core layer has an absorption capacity of up to 17 grams per gram of its basis weight.

19. A disposable flexible article according to claim 2 wherein said core layer has an absorption capacity of up to 17 grams per gram of its basis weight.

20. A disposable flexible article according to claim 1 wherein said core layer has an stretch capacity of from 30% to 75%.

21. A disposable flexible article according to claim 2 wherein said core layer has an stretch capacity of from 30% to 75%.

22. A substantially dry disposable flexible article useful for cleans and conditioning skin, adapted for inclusion of a cleansing and moisturizing solution for controlled and repeated release thereof, comprising:
a) a first water insoluble non woven layer comprised substantially of synthetic fibers having outer and inner surfaces,
b) a water insoluble core layer made of a cellulosic wadding material having a density of less than 0.3 grams per cubic centimeter, having an stretch capacity of at least 30%, having an absorbent capacity of at least 12 grams per gram of its basis weight, and incorporating about 25 to about 300% of the article's total basis weight of a cleansing and moisturizing solution including a surfactant adapted for cleansing and conditioning skin,
c) a second water insoluble non-woven layer comprised substantially of synthetic fibers having inner and outer surfaces wherein the core layer is positioned between the inner surfaces of said first and second layers and the first, second and intermediate core layers are mechanically through-bonded by needling to form a unified article having perforations of less formed during said mechanical bonding, wherein said perforations assist in controlling water absorption into the core required for activating the cleansing and moisturizing solution and for the controlled and repeated release thereof on its activation by said absorbed water.
